(19) United States
(12) Patent Application Publication
(10) Pub. No.: US 2013/0125664 A1
(43) Pub. Date: May 23, 2013

(54) WIRELESS FLOW MONITORING DEVICES

(71) Applicant: Ronald D. Harper, JR., Georgetown, IN (US)

(72) Inventor: Ronald D. Harper, JR., Georgetown, IN (US)

(21) Appl. No.: 13/299,037

(22) Filed: Nov. 17, 2011

(51) Int. Cl. G01F 1/56

(52) U.S. Cl. 73/861.08

(57) ABSTRACT

Wireless flow monitoring devices are described. In one example, a device to wirelessly monitor a flow of material is described that includes a housing having a first surface and a second surface opposite the first surface, the second surface having an aperture, a lever secured within the housing to move in response to the flow of material, and a paddle arm forming at least a portion of a first arm of the lever, where an end of the paddle arm extends out the aperture of the second surface of the housing, and where a paddle is affixed to the paddle arm to be positioned within the flow of material. The device includes a magnet that is actuated by a second arm of the lever to move an amount proportional to the first arm of the lever, a portion of the magnet extending beyond the first surface of the housing so that a motion path of the portion of the magnet extending beyond the first surface of the housing is disposed within a channel of a wireless position monitor mounted to the first surface of the housing, where the channel serves as a sensor to detect movement of the magnet.

### FIELD OF THE DISCLOSURE

This patent relates generally to flow control devices and, more particularly, to wireless flow monitoring devices.

### BACKGROUND

The flow of material (e.g., fluids, solids, etc.) in pipelines or other conduits is an important function in modern industrial and commercial processes. In many settings, it is important to monitor and detect whether material is flowing in a pipeline or other conduit and to respond in accordance with an overall control strategy. In many applications, one or more flow switches may be used for this purpose.

Many known flow switches function to complete (make) or interrupt (break) an electrical circuit when a flow or a no-flow condition is detected within a pipeline. Cables wired to the electrical circuit may electrically couple the flow switch to a process controller, a motor or pump, and/or any other device within a process control system to provide or assert a signal when flow stops, remove or shut off a signal when flow is adequate, start a motor in response to detecting a flow, stop a motor in response to a no-flow condition, or implement any other appropriate action.

### SUMMARY

Wireless flow monitoring devices are described. In one example, a device to wirelessly monitor a flow of material is described that includes a housing having a first surface and a second surface opposite the first surface, the second surface having an aperture, a lever secured within the housing to move in response to the flow of material, and a paddle arm forming at least a portion of a first arm of the lever, where an end of the paddle arm extends out the aperture of the second surface of the housing, and where a paddle is affixed to the paddle arm to be positioned within the flow of material. The device includes a magnet that is actuated by a second arm of the lever to move an amount proportional to the first arm of the lever, a portion of the magnet extending beyond the first surface of the housing so that a motion path of the portion of the magnet extending beyond the first surface of the housing is disposed within a channel of a wireless position monitor mounted to the first surface of the housing, where the channel serves as a sensor to detect movement of the magnet.

In another example, a wireless flow monitoring device includes an enclosure having a bottom surface and a top surface, a paddle arm coupled to the enclosure and extending out an opening in the bottom surface of the enclosure, and a paddle affixed to the paddle arm, the paddle and the paddle arm forming a first lever arm to rotate about a pivot point within the enclosure in response to material flowing within a pipe. The device also includes a second lever arm to rotate about the pivot point an amount proportional to the rotation of the first lever arm, a portion of the second lever arm extending beyond the top surface of the enclosure, the portion of the second lever arm having a magnetic array to be positioned within a sensor channel of a wireless position monitor to detect movement of the magnetic array.

In yet another example, a flow monitoring device includes a housing having a cavity formed by a base and a cover, a hollow body affixed to the base about an opening in a first surface of the base, the hollow body enabling the device to be installed on a conduit through which material flows, the flow of the material being monitored by the device, and a paddle arm extending through the opening in the first surface of the base through the hollow body, the paddle arm being coupled to the housing to enable the paddle arm to rotate in response to the flow of the material within the conduit. The device further includes a paddle affixed to the paddle arm and positioned within the conduit and a magnet extending from the pivot joint in a direction substantially opposite the paddle arm to rotate an amount proportional to the rotation of the paddle arm, the magnet extending beyond a top surface of the housing to enable a position monitor to be mounted to the device to monitor the flow of the material by monitoring the rotation of the magnet.

### BRIEF DESCRIPTION OF THE DRAWINGS

FIG. 1A is an illustration of a known paddle type flow switch.

FIG. 1B is an exploded view of the known flow switch shown in FIG. 1A.

FIG. 2 is a perspective view of an example flow switch attached to a wireless position monitor in accordance with the teachings of this disclosure.

FIG. 3 is another known paddle type flow switch shown in disassembled form.

FIG. 4 is a perspective view of another example flow switch attached to the wireless position monitor of FIG. 2 in accordance with the teachings of this disclosure.

FIG. 5 is an illustration of an example fully-assembled flow switch according to the teachings of this disclosure.

### DETAILED DESCRIPTION

In accordance with many known approaches, a flow switch may be integrated within a process control system by physically wiring the flow switch into the control system. Such wiring can incur significant costs, both upfront during set up and installation, as well as during ongoing maintenance. These known approaches may require a lot of electrical wires/cables and/or may increase the amount and/or the size of conduits used to run the wires within the process control system as well as the sizes of cable trays. Also, wiring can be costly and/or impractical in locations that are difficult to access and install the wiring. Furthermore, additional wiring in a process control system may require expansion cards for a process controller to provide additional input points to connect each wire to the controller to enable all components to properly communicate, thereby incurring additional cost and/or inconvenience. Additionally, electrically wiring a flow switch may not be approved for use in hazardous (classified) areas where unsafe environments (e.g., class I—flammable gases or vapors, class II—combustible dust, etc.) pose a risk of explosion or other danger.

The foregoing problems may be alleviated by communicating the flow monitored by flow switches via intrinsically safe wireless technology. By wirelessly communicating the flow measured by a flow switch, it is possible to eliminate the labor and expense of installing electrical cables, running the cables across a process space through conduits, and finding available input points to physically terminate the wires with connections to a controller and/or other device. Instead, a single gateway may receive wireless signals from multiple components and communicate each of those signals via Hart, OLE for Process Control (OPC), modbus Ethernet, serial 485, or any other communication protocol without the need for discrete input cards to receive separate wires from each additional component. Furthermore, monitoring flow without hardwired flow switches enables the monitoring of material flow at locations that would be otherwise difficult and/or impractical to access via many known methods.

Additionally, many known implementations of wireless technology include wireless devices designed to be intrinsically safe so as to be approved for use in hazardous (classified) environments. For example, it is known that an intrinsically safe wireless position monitor may be attached to a control valve to detect movement of the valve shaft or stem to determine the position of the valve and communicate the position back to a controller without the need to run physical wires in a process space. However, many of the known flow switches cannot be connected to wireless position monitors in a manner that enables the position monitors to obtain a reliable reading of the flow switch. As such, with these known approaches, the only recourse is to either physically wire a flow switch to a process control system (with all its related costs and limitations on the type of environment) or to forego measuring flow at that particular location within the process control system.

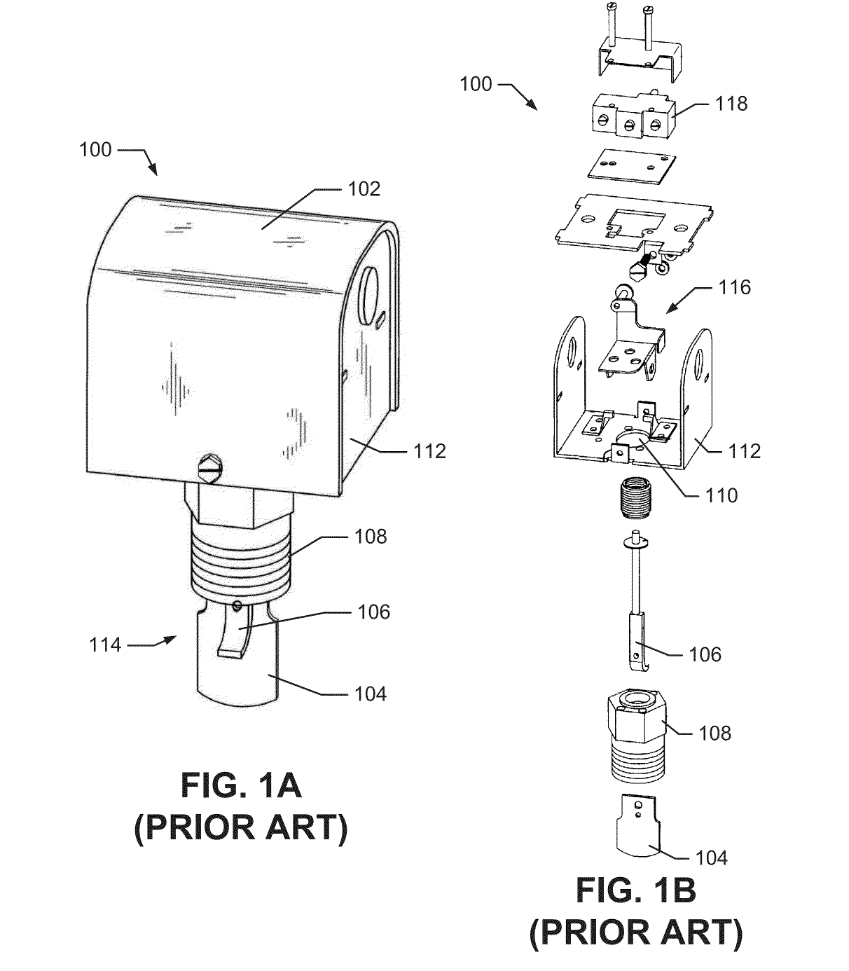

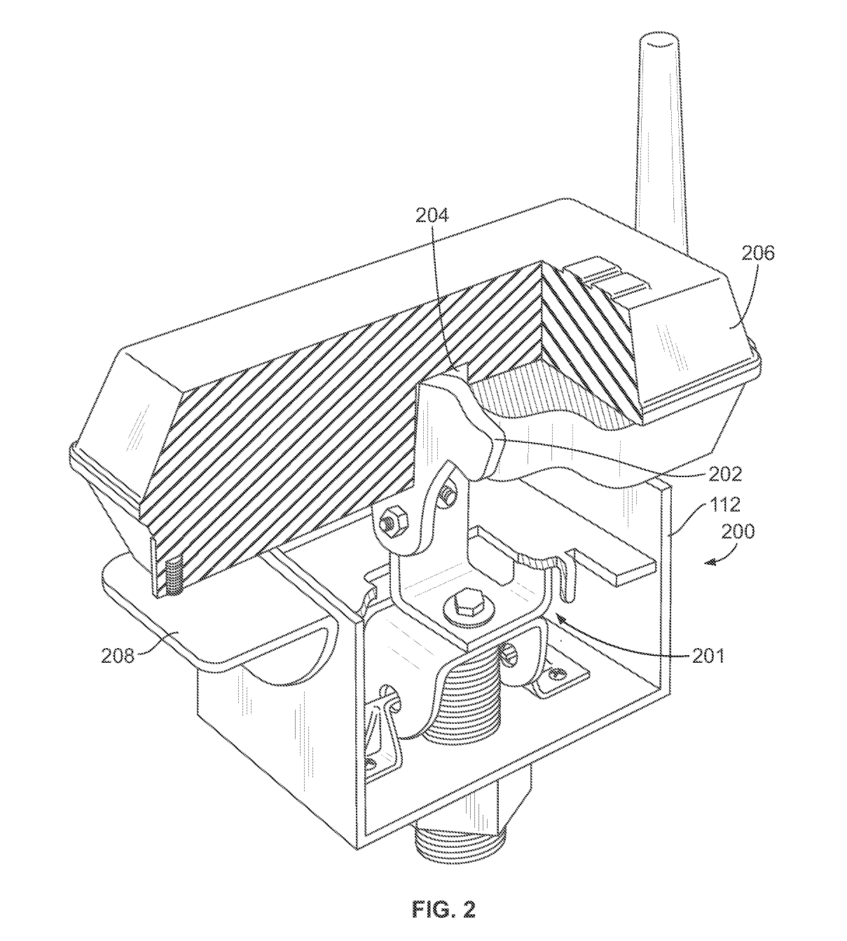

FIGS. 1A and 1B illustrate a known paddle type flow switch 100. Specifically, FIG. 1A illustrates the flow switch 100 completely assembled with a cover 102 and FIG. 1B illustrates an exploded view of the flow switch 100 without the cover 102 to show the internal components of the flow switch 100. The flow switch 100 is similar in some respects to the flow switch described by Shafique et al. in U.S. Pat. No. 6,563,064, which is hereby incorporated herein by reference in its entirety. While a complete description can be obtained from Shafique et al., in summary, the flow switch 100 includes a paddle 104 attached to a paddle arm 106 that extends through a pipe adapter 108 and through an opening 110 of a bracket, base, or housing 112 of the flow switch 100. In use, the flow switch 100 is coupled to a pipe (pipe used herein includes pipe or any other conduit) with the paddle 104 extending into the pipe to interact with material in the pipe. The paddle 104 and paddle arm 106 are configured to act as a first lever arm 114 that is moved or displaced by a change in the flow of material in the pipe to actuate a second lever arm 116 that engages or actuates an electrical switch 118 (e.g., a snap switch). Once engaged, the electrical switch 118 may provide a signal (e.g., a contact closure) to a component in a process control system that has been physically wired to the flow switch 100.

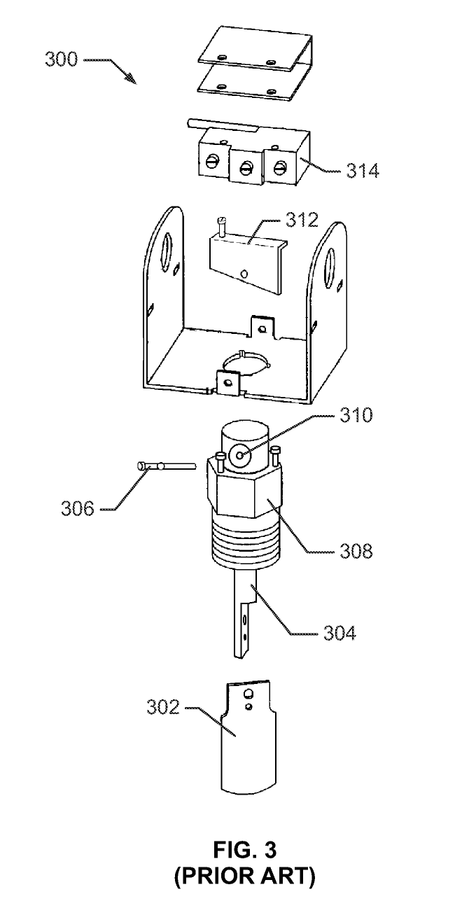

FIG. 2 is a perspective view of an example flow switch 200 attached to a wireless position monitor 206 in accordance with the teachings of this disclosure. The example flow switch 200 may be similar in some respects to the flow switch 100 shown in FIGS. 1A and 1B. However, the example flow switch 200 has been modified as discussed below.

Attached to a second lever arm 201 is an array of magnets 202 (which may be referred to as a target array) configured to extend beyond the top of the base 112. By coupling, either directly or indirectly, the target array 202 to the second lever arm 201, the target array 202 acts as an extension of the second lever arm 201 and moves about a fulcrum of the lever an amount proportional to the movement of the paddle 104 when flow conditions within a pipe change. The target array 202, which extends beyond the top of the base 112, is configured to be positioned within a channel 204 of a wireless position monitor 206 such that when the target array 202 moves along the channel 204, the position monitor 206 can measure that movement to indicate the material flow conditions within a pipe. While the position monitor 206 may detect smaller movements, the target array 202 may span at least ¼″ along the channel 204. To ensure accurate and reliable measurements, the position monitor 206 may be securely mounted to the flow switch 200 via, for example, a bracket 208. Once movement of the paddle 104 has been detected via the position monitor 206 detecting movement of the target array 202, the position monitor 206 may wirelessly transmit the collected data to a process controller and/or other device for analysis and/or other response.

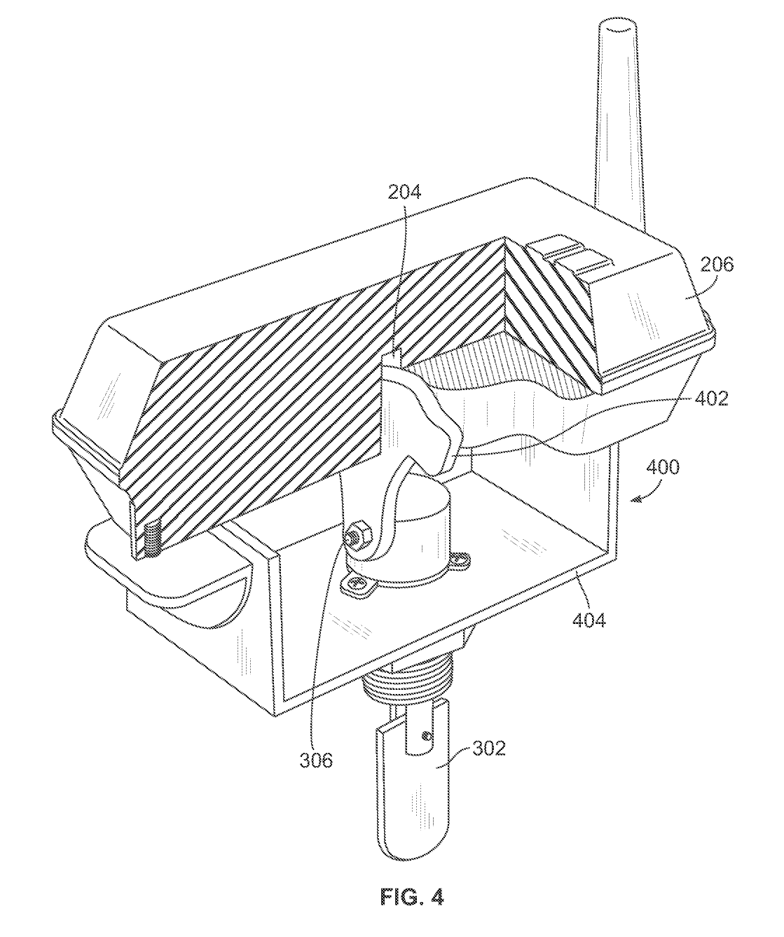

FIG. 3 depicts another known paddle type flow switch 300 shown in disassembled form. The flow switch 300 of FIG. 3 is similar to the flow switches described by Garvey in U.S. App. Pub. No. 2008/0258088, which is hereby incorporated herein by reference in its entirety. While a complete description can be obtained from Garvey, in summary, the flow switch 300 includes a paddle 302 attached to a paddle arm 304 that extends inside a pipe adapter 308 and connects to a pivot pin or rod 306 that extends across the pipe adapter 308 through an aperture 310. A lever arm 312 is coupled to an end of the pivot rod 306 to rotate about the pivot rod 306 an amount proportional to the rotation of the paddle arm 304 when a change in flow of material in a pipe causes the paddle 302 to move. The movement of the lever arm 312 is configured to actuate an electrical switch 314 (e.g., a snap switch), which may be physically wired to communicate with other components in a process control system.

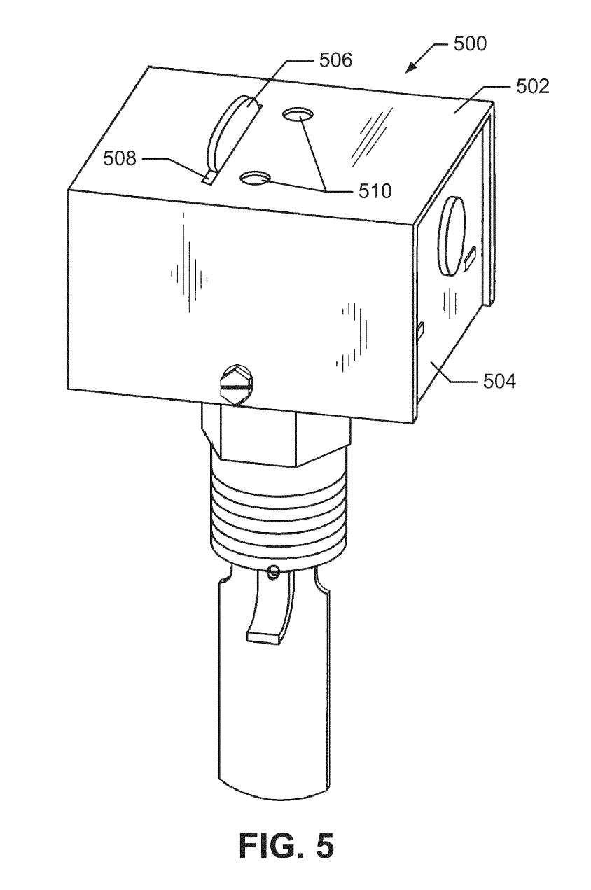

FIG. 4 is a perspective view of another example flow switch 400 attached to the wireless position monitor 206 of FIG. 2 in accordance with the teachings of this disclosure. The example flow switch 400 is similar in some respects to the flow switch 300 shown in FIG. 3. However, the flow switch 400 has been modified as discussed below. A target array 402 is coupled either directly or indirectly to an end of the pivot rod 306 to rotate about the pivot rod 306 an amount proportional to the movement of the paddle 302. The wireless position monitor 206 may be mounted to the flow switch 400 to securely position the target array 402 within the channel 204 of the position monitor 206. To position the target array 402 within the channel 204 of the position monitor 206, the target array 402 may be configured to extend beyond the top of a base 404 of the flow switch 400 as illustrated in FIG. 4.

The wireless position monitor 206 shown in FIGS. 2 and 4 may be a model 4310 Wireless position monitor made by TopWorx Inc., a subsidiary of Emerson Electric Company. However, the teachings of this disclosure may be implemented using any other wireless position monitor. Use of the wireless position monitor 206 enables the use of flow switches (e.g., the example flow switches 200 and 400) in virtually any location without the need to run electric wires and/or conduit throughout a process control system. Not only may this provide significant cost savings in installation and maintenance, it also simplifies the linking of multiple devices to a controller because a single gateway can receive numerous wireless signals, whereas hardwiring multiple devices requires each device to have an independent input point.

Additionally, wireless position monitors, such as the position monitor 206, may be intrinsically safe. Thus, these wireless position monitors are approved for any environment (i.e., both hazardous and non-hazardous work conditions). More specifically, these wireless position monitors can be implemented with the disclosed example flow switches 200 and 400 in any environment because the flow switches 200, 400 are purely mechanical devices that do not require any electrical connections unlike many known flow switches. This is made possible by the linkage-less and/or non-contact detection of movement of the target arrays 202 and 402 by the position monitor 206. Furthermore, not only may the position monitor 206 be intrinsically safe during operation, it may have intrinsically safe power modules (e.g., batteries). As a result, if allowed under standard operating procedures of the particular process system, a user may change the power modules in the field without the need for obtaining a hot work permit. Alternatively, the position monitor 206 may use local power to power its operation. While this implementation requires a power cord, it still avoids the use of wiring electrical cables up as with many other known flow switches.

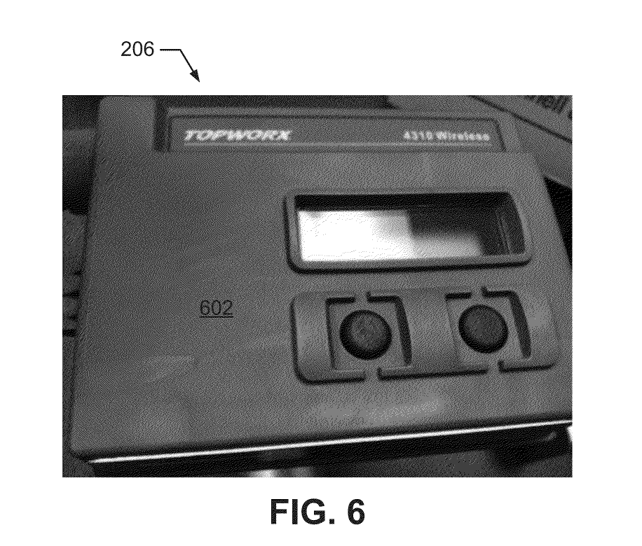

FIG. 5 depicts an example flow switch 500 according to the teachings of this disclosure. As with known flow switches, the example flow switch 500 includes a cover 502 that attaches to a base 504. However, the cover 502 is adapted to provide space for a target array 506 to extend beyond the top of the flow switch 500 via a notch or slot 508. This allows the target array 506 to pass through the channel 204 of the position monitor 206 (shown in FIGS. 2 and 4) for reliable monitoring of the flow switch 500. Furthermore, the cover 502 also includes holes 510 to enable the position monitor 206 to be secured to the flow switch 500. Additionally, the cover 502 may be flat to facilitate the mounting of the position monitor 206.

The example cover 502 of the flow switch 500 may be applied to either of the example flow switches 200 or 400 described above. Furthermore, an alternative configuration (not shown) of the example cover 502 may include a hollow protrusion in which the target array 506 may sit. Such a protrusion may be dimensioned to fit within the channel 204 of the position monitor 206 to enable the internal mechanisms of the flow switch 500 to be completely enclosed.

Similarly, the example flow switches 200, 400, and 500 disclosed herein are provided by way of example only. Any other configuration of the base (e.g., the base 112 of FIG. 2), the lever arms (e.g., the second lever arm 116 of FIG. 2), the target array (e.g., the target array 202 of FIG. 2), the cover (e.g., the cover 502 of FIG. 5) and/or the method of mounting the position monitor 206 that is similar to that which is disclosed herein is contemplated by this disclosure. For example, while FIGS. 2 and 4 show the flow switches 200 and 400 without an associated electrical switch (e.g., the switch 118 shown in FIG. 1A), the example flow switches 200 and 400 may be configured to include an electrical switch 118 as well as a target array (e.g., the target array 202) to enable hardwired and/or wireless implementations of the flow switches 200 and 400.

Furthermore, the example flow switches 200, 400, and 500 described herein may be implemented in virtually any process control system. For instance, the example flow switches described herein may be applied to conditions of both vacuum and positive flow in either batch or continuous processes. Furthermore, the example flow switches described herein are suitable for detecting the flow of virtually any material including liquids, gases, and/or powder/dust.

What is claimed is:

1. A device to wirelessly monitor a flow of material, comprising:
a housing having a first surface and a second surface opposite the first surface, wherein the second surface has an aperture;
a lever secured within the housing, the lever to move in response to the flow of material;
a paddle arm forming at least a portion of a first arm of the lever, the paddle arm having first and second ends, the first end extending out the aperture iii of the second surface of the housing;
a paddle affixed to the paddle arm to be positioned within the flow of material;
a magnet to move an amount proportional to the first arm of the lever, the magnet actuated by a second arm of the lever, and a portion of the magnet extending beyond the first surface of the housing; and
so that a motion path of the portion of the magnet extending beyond the first surface of the housing is disposed within a channel of a wireless position monitor mounted to the first surface of the housing, wherein the channel serves as a sensor to detect movement of the magnet.

2. A device as described in claim 1, further comprising:
a pipe adapter affixed to the second surface of the housing to enable the device to be connected to a pipe;
a bracket pivotally mounted to the housing to serve as a pivot point for the lever, the second end of the paddle arm affixed to the bracket, and the magnet being connected to the bracket; and
a bellows positioned between the bracket and the second surface of the housing and surrounding the paddle arm to form a seal against the second surface of the housing.

3. A device as described in claim 1, further comprising:
a pipe adapter affixed to the second surface of the housing to enable the device to be connected to a pipe, a first end of the pipe adapter extending into the housing through the aperture, the pipe adapter having an opening at a second end and being enclosed at the first end;
a pivot rod extending across the pipe adapter adjacent the first end of the pipe adapter to serve as a pivot point for the lever, the second end of the paddle arm coupled to the pivot rod within the opening of the pipe adapter, and an end of the pivot rod extending out a side of the pipe adapter, wherein the magnet is connected to the end of the pivot rod; and
sealing rings positioned between the pivot rod and the pipe adapter to seal off the second surface of the housing.

4. A device as described in claim 1, wherein the magnet extends through a notch in the first surface of the housing.

5. A device as described in claim 1, further comprising a hollow protrusion extending out from the first surface of the housing and dimensioned to fit within the channel of the wireless position monitor and enclose the portion of the magnet extending beyond the first surface of the housing.

6. A device as described in claim 1, wherein the magnet is an extension of the second lever arm.

7. A device as described in claim 1, wherein the first and second arms of the lever are dimensioned to enable the motion path of the magnet to span at least one-quarter of an inch.

8. A wireless flow monitoring device, comprising:
an enclosure having a bottom surface and a top surface;
a paddle arm coupled to the enclosure and extending out an opening in the bottom surface of the enclosure;
a paddle affixed to the paddle arm, the paddle and the paddle arm forming a first lever arm to rotate about a pivot point within the enclosure in response to material flowing within a pipe; and
a second lever arm to rotate about the pivot point an amount proportional to the rotation of the first lever arm, a portion of the second lever arm extending beyond the top surface of the enclosure, the portion of the second lever arm having a magnetic array to be positioned within a sensor channel of a wireless position monitor to detect movement of the magnetic array.

9. A device as described in claim 8, wherein the magnetic array extends through a slot in the top surface of the enclosure.

10. A device as described in claim 8, further comprising a hollow protrusion extending out from the top surface of the enclosure and dimensioned to fit within the sensor channel of the wireless position monitor and enclose the portion of the second lever arm extending beyond the top surface of the enclosure.

11. A device as described in claim 8, wherein the wireless position monitor is mounted on the device via a bracket connected to the enclosure and to the wireless position monitor.

12. A device as described in claim 8, wherein the top surface of the enclosure is substantially flat and contains holes to enable the mounting of the wireless position monitor.

13. A device as described in claim 8, wherein the material is at least one of a liquid, a gas, a powder, or a solid.

14. A flow monitoring device, comprising:
a housing having a cavity formed by a base and a cover;
a hollow body affixed to a first surface of the base about an opening in the first surface of the base, the hollow body enabling the device to be installed on a conduit through which material flows, the flow of the material being monitored by the device;
a paddle arm extending through the opening in the first surface of the base through the hollow body, the paddle arm being coupled to the housing to enable the paddle arm to rotate in response to the flow of the material within the conduit;
a paddle affixed to the paddle arm and positioned within the conduit; and
a magnet extending from the pivot joint in a direction substantially opposite the paddle arm to rotate an amount proportional to the rotation of the paddle arm, the magnet extending beyond a top surface of the housing to enable a position monitor to be mounted to the device to monitor the flow of the material by monitoring the rotation of the magnet.

15. A device as described in claim 14, wherein the magnet extends through a notch in a top surface of the cover.

16. A device as described in claim 14, further comprising a hollow protrusion extending out from the top surface of the housing and dimensioned to fit within a sensor channel of the wireless position monitor and enclose the portion of the magnet extending beyond the first surface of the housing.

17. A device as described in claim 14, further comprising an electrical switch to complete or interrupt an electrical circuit when actuated by movement of the lever.

18. A device as described in claim 14, wherein the flow that is being monitored is at least one of positive flow or vacuum flow.

19. A device as described in claim 14, wherein the device is intrinsically safe to be used in hazardous.

20. A device as described in claim 14, wherein the device is used in at least one of continuous processes or batch processes.
